(19) United States
(12) Patent Application Publication
(10) Pub. No.: US 2006/0085565 A1
(43) Pub. Date: Apr. 20, 2006

(54) Method of configuring device property of storage device for a windows operating system

(75) Inventors: Yu Rui, Shan hai (CN); Lian-Jen Tian, Shan hai (CN); Hui Qin Yang, Shan hai (CN); Tang Song Li, Shan hai (CN)

Correspondence Address: G. LINK Co., LTD., PMB 174, 931 West 75th Street, Suite 137, Naperville, IL, 60565, US

(73) Assignee: FIRST INTERNATIONAL COMPUTER, Inc.

(21) Appl. No.: 10/966,516

(22) Filed: Oct. 18, 2004

(51) Int. Cl. G06F 3/00

(52) U.S. Cl. 710/8

(57) ABSTRACT

This invention discloses a method of configuring a device property of a storage device for a Windows operating system. A step (A) is to code a lower-level filter driver for intercepting and processing an I/O request packet (IRP) that queries a storage device property. The IRP of the step (A) is passed through the lower-level filter driver. A step (B) is to insert the lower-level filter driver between a storage class driver and a bus filter driver. A step (C) is to change an original device property of the IRP corresponding to the storage device when the computer is booted and the lower-level filter driver is executed.

### FIELD OF THE INVENTION

The present invention relates to a method of configuring a device property of a storage device for a Windows operating system, more particularly to a method of changing the original device property of a storage device for a Windows operating system, such that the storage device simulates a storage device of another class.

### BACKGROUND OF THE INVENTION

A conventional Windows operating system such as a Windows 2000/XP/XP embedded operating system sets a storage device to its default device property; for example, a fixed storage device of a hard disk drive is set to a fixed device property or a removable storage device of a CF (Compact Flash) memory card is set to a removable device property. These device properties are default according to the types of the device. In other words, the conventional Windows operating system assigns a default device property to each of these storage devices, and also comes with a driver for each of these storage devices, which means that the program codes are coded according to the default device property. If the way of changing the device property of the storage device is to rewrite the codes of a device driver, then the device driver designated for individual storage device must be reprogrammed. Such arrangement is not a general solution. The selection of the storage device is limited, because users can only select the storage device that comes with a driver for changing its device property.

### SUMMARY OF THE INVENTION

The primary objective of the present invention is to provide a method for changing an existing defined device property of a storage device.

The second objective of the present invention is to provide a method of changing an existing defined device property of a storage device for a driver without being limited to different types of storage devices.

The third objective of the present invention is to simulate a removable storage device as a fixed storage device.

The fourth objective of the present invention is to simulate a fixed storage device as a removable storage device.

To achieve the foregoing objectives, the method of using a Windows operating system to configure the device property of a storage device according to the present invention comprises the steps of:
Step (A): coding a lower-level filter driver; wherein the lower-level filter driver is used for intercepting and processing an I/O request packet that queries a storage device; wherein the IRP is passed through the lower-level filter driver;
Step (B): inserting the lower-level filter driver between a storage class driver and a bus filter driver; and
Step (C): When a computer is booted, the lower-level filter driver executed by the computer changes the original device properties of the IRP corresponding to a storage device.

### BRIEF DESCRIPTION OF THE DRAWINGS

The present invention can be more fully understood by reference to the following description and accompanying drawings, in which:

FIG. 1 is a flow chart of the present invention;

FIG. 2 is a block diagram of the lower-level filter being related with other drivers according to the present invention;

FIG. 3 is a flow chart of processing the lower-level filter driver according to the present invention;

FIG. 4 is a data structure diagram of the storage device descriptor of the storage device according to the present invention;

FIG. 5A shows the device property of a removable storage device when not implementing the method of the present invention;

FIG. 5B shows the method of changing the device property of a removable storage device to the device property of a fixed storage device according to the present invention;

FIG. 6 shows the numeric values of the device property of a removable storage device before and after the change according to the present invention;

FIG. 7A shows the device property of a fixed storage device when not implementing the method of the present invention;

FIG. 7B shows the method of changing the device property of a fixed storage device to the device property of a removable storage device according to the present invention; and

FIG. 8 shows the numeric values of the device property of a fixed storage before and after the change according to the present invention.

### DETAILED DESCRIPTION OF THE INVENTION

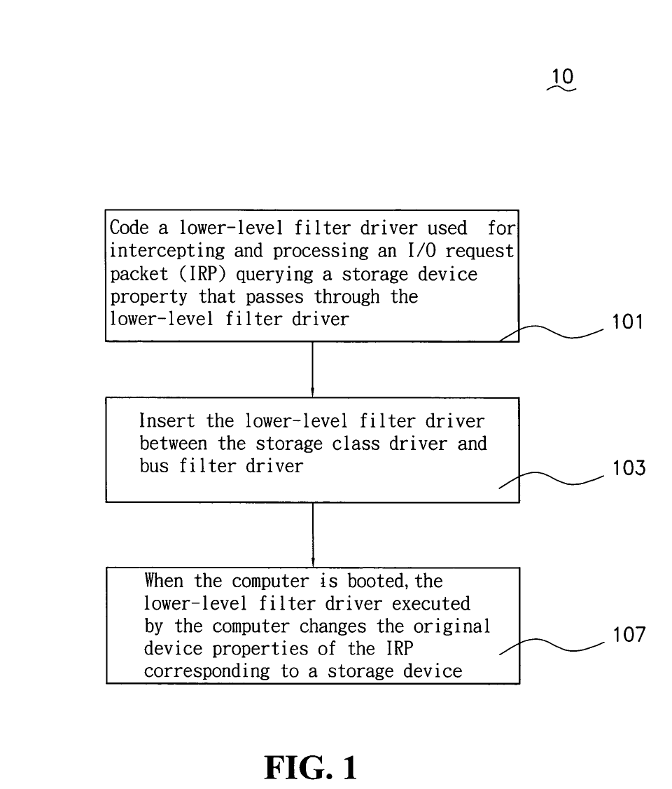

Please refer to FIG. 1 for the flow chart of the present invention. The method 10 of configuring a device property for a storage device for a Windows operating system can be used to change the original device property of a storage device more convenient. For example, the device property of a hard disk drive is defaulted to a fixed device by a Microsoft Windows operating system. After the configuration method 10 is executed, the Windows operating system will set the device property of the hard disk drive as a removable device. For example, a CF (Compact Flash) memory card originally considered as a removable device by a Microsoft Windows operating system is changed to a fixed device after executing method 10. The step 101, 103, 105 of the configuration method 10 will be described as follows.

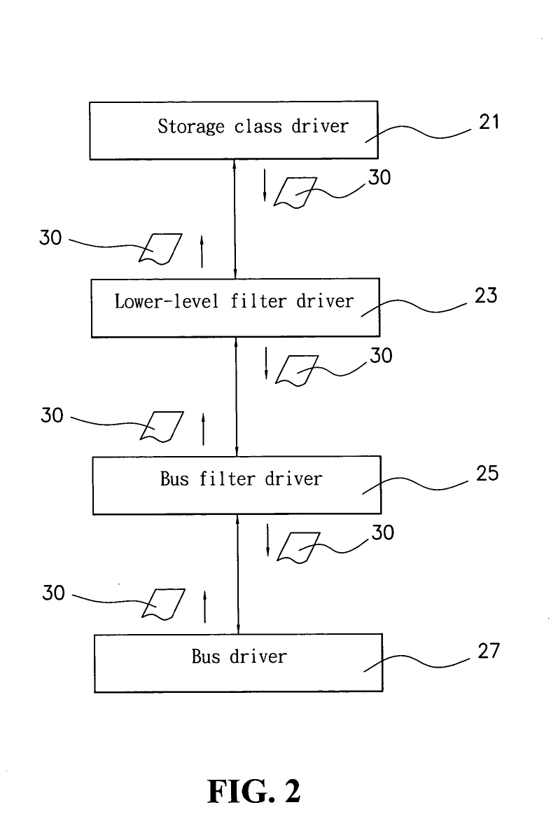

Please refer to FIG. 2 for the block diagram of the lower-level filter driver being related with other drivers according to the present invention. The Step 101 codes a lower-level filter driver 23 used for intercepting and processing an I/O request packet (IRP) 30 querying a storage device property that passes through the lower-level filter driver 23. The Step 103 inserts the lower-level filter driver 23 between a storage class driver 201 and a bus filter driver 25. The Step 105 changes the original device properties of the IRP 30 corresponding to a storage device after the computer is booted and the lower-level filter driver 23 is executed by the computer. As to the persons skilled in the art, the present invention adopts a storage class driver 21, a bus filter driver 25, and a bus driver 27 in the foregoing steps 101, 103, 105, and all these drivers 21, 25, 27 have been used in the driver of the Microsoft Windows operating system. The lower-level filter driver 23 provided by the invention is coded according to the WDM specification.

When a computer is booted by a Microsoft Windows operating system, the computer will load and run a storage device driver. In this process, the Windows operating system will produce a special IRP 30 first, and the IRP 30 will be sent level to level down towards the bus driver 27 according to the WDM hierarchy, and queried by the IRP 30 to a lower level one by one in order to query the device property of the storage device. After the driver of a certain level obtains the device property of the storage device, this IRP 30 will be sent reversely to the higher level from the lower level. In the meantime, the IRP 30 passes through the driver of each level. If it is necessary to query the device property of a storage device, then the information is obtained directly from such IRP 30.

The technical characteristic of the Step 103 according to the invention resides on inserting the lower-level driver 23 at an appropriate position in the hierarchy of the level driver structure, such that the queried device property of the IRP 30 can be intercepted successfully. In the meantime, it will not bring any adverse effect on the operation of the system. When the lower-level driver 23 returns, the lower-level driver 23 modifies the numeric value of the corresponding device property of the storage device and returns the numeric value to an upper-level driver. The measure taken by the Step 103 of the invention resides on inserting the lower-level driver 23 between the storage class driver 21 and a bus filter driver 25.

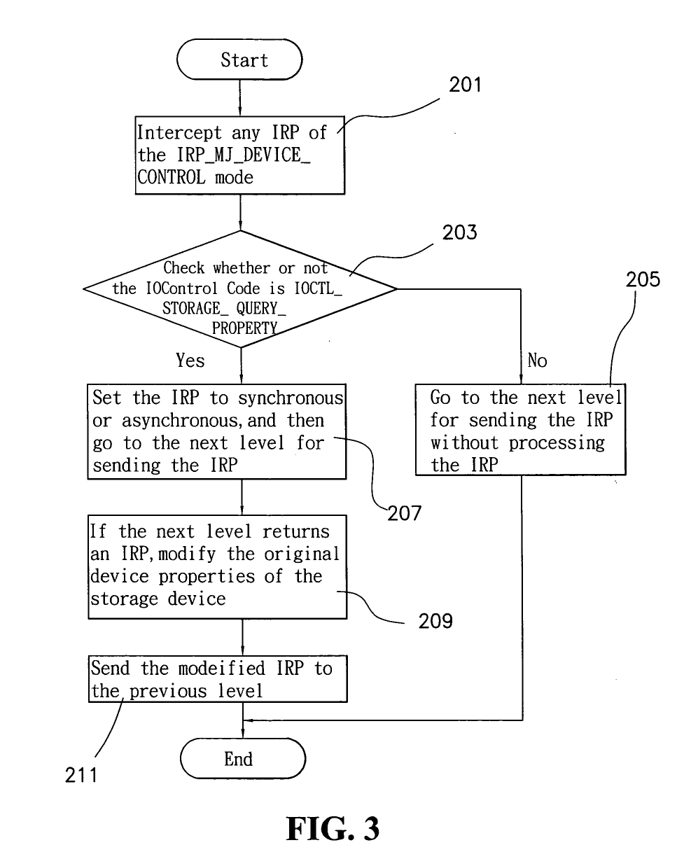

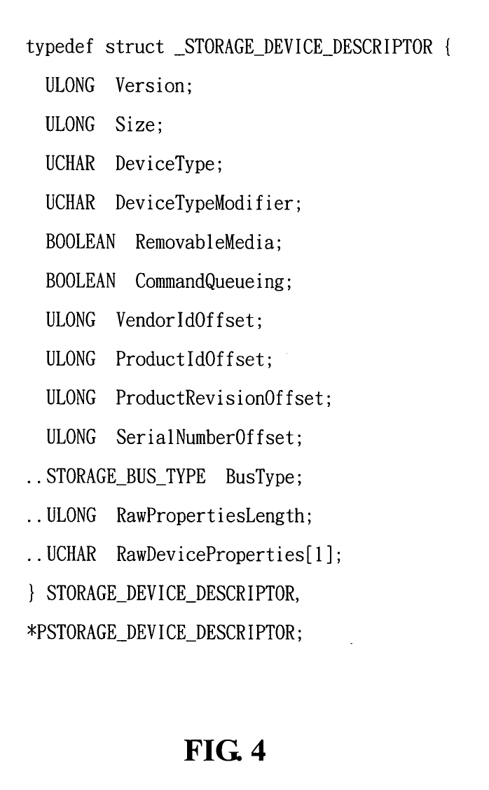

FIG. 3 shows the flow chart of the lower-level driver of the present invention and FIG. 4 shows the data structure of the storage device descriptor of the storage device of the present invention. In Steps 201 and 203, all of the intercepted IRP 30 in the IRP_MJ_DEVICE_CONTROL mode are passed to the lower-level filter driver 23, and the IOControl Code is checked whether or not it is of the IOCTL_STORAGE_QUERY_PROPERTY; if it is true, then the procedure will go to Step 207, or else go to Step 205. If the procedure goes to Step 205, then the lower-level filter driver 23 will not process the IRP 30, but the IRP 30 will be sent directly downward to the bus filter driver 25. Step 207 sends the IRP 30 either synchronously or asynchronously, and then down to the bus filter driver 25. In Step 209, when the lower level of the bus filter driver 25 returns the IRP 30, the lower-level filter driver 23 modifies the original device property of the storage device. In Step 211, the lower-level filter driver 23 sends the modified IRP 30 to the upper level of the storage class driver 21.

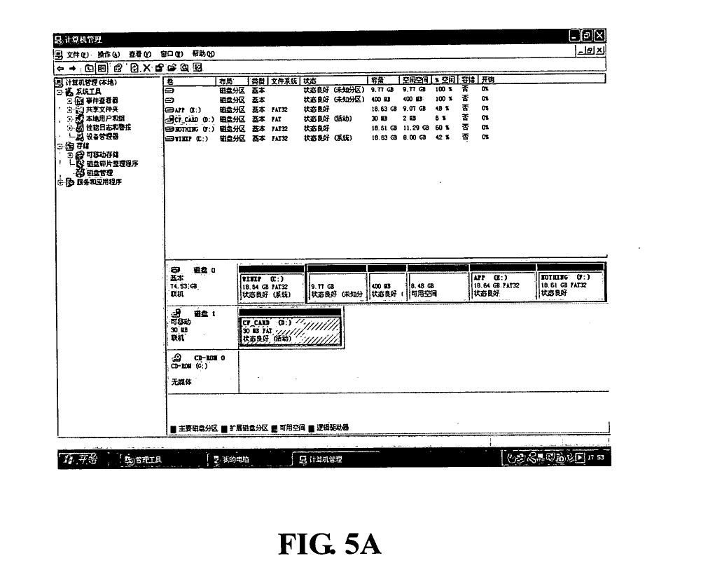

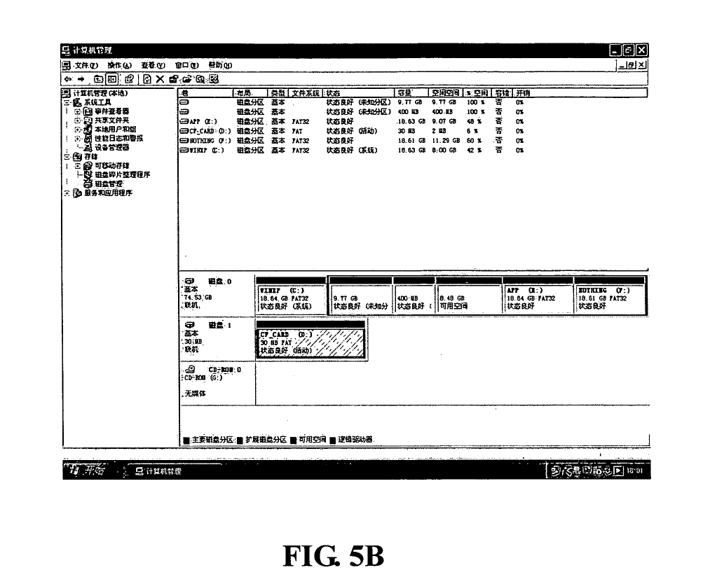

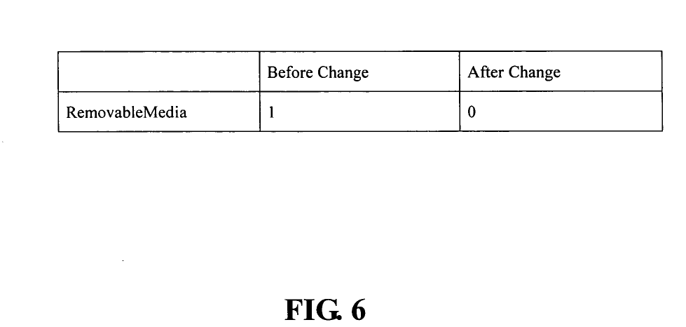

FIG. 5A shows the device property of a removable storage device provided that the method of the invention is not implemented; FIG. 5B shows that the method of the invention changes the device property of a removable storage device to a fixed device property; and FIG. 6 shows the numeric value before and after changing the device property of the removable storage device. For example, a removable storage device such as a CF memory card or a MD (Micro Drive) in the Microsoft Windows XP embedded operating system has not built the method 10 of the invention in the operating system, and thus the CF memory card or the MD is identified as a removable storage device, and as a result, the CF memory card or the MD cannot have the page-file function and cannot use the enhanced write filter (EWF) function provided by the Windows XP Embedded operating system. If the Microsoft Windows XP Embedded operating system is built using the method 10 of the invention, then the CF memory card or the MD can have the page-file function. In other words, the Windows XP Embedded operating system can use the file corresponding to the virtual memory in the CF memory card or the MD, and thus providing a significant effect of improving the system performance. In the meantime, the EWF function can be maximized and protects one or more blocks in the CF memory card or the MD, so that users can use the EWF function to easily drive the system to produce a failure after any modification or recover the previous status before any modification is made.

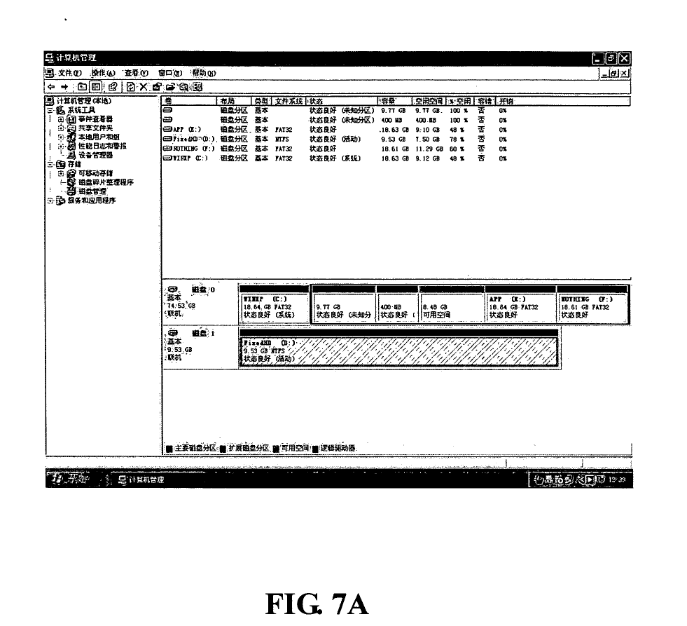

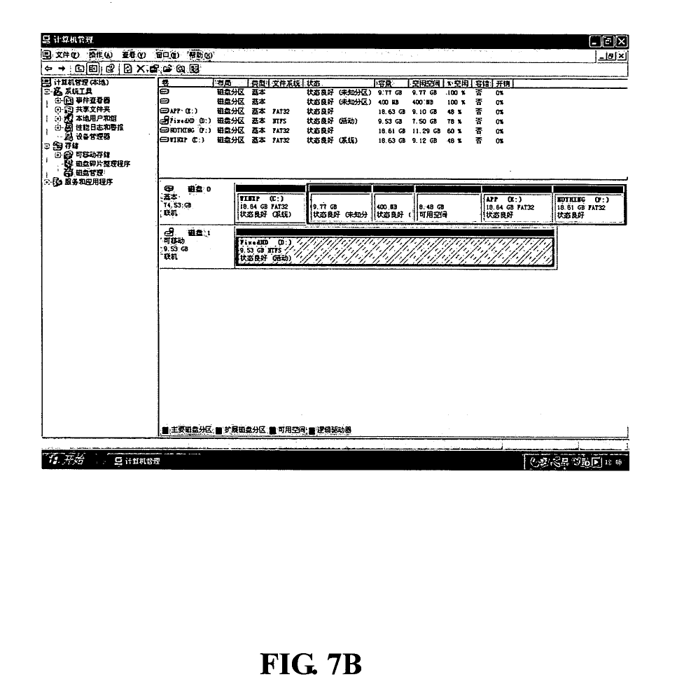

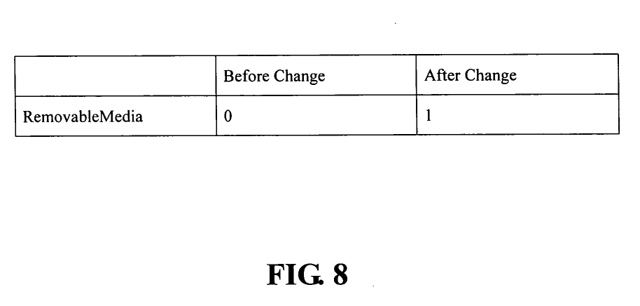

FIG. 7A shows the device property of a fixed storage device provided that the method of the invention has not been implemented; FIG. 7B shows the fixed storage being changed to the removable device property by the method of the invention; and FIG. 8 shows the numeric values before and after the device property of the fixed storage device is changed. With the configuration method 10 of the invention, the device property of a fixed storage device can be changed to the device property of a removable storage device immediately after the computer is booted.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of configuring device property of storage device by using Windows operating system, comprises the steps of:
(A) coding a lower-level filter driver for intercepting and processing an I/O request packet (IRP) that queries a storage device property, wherein said IRP is passed through said lower-level filter driver;
(B) inserting said lower-level filter driver between a storage class driver and a bus filter driver; and
(C) changing an original device property of said IRP corresponding to a storage device when booting a computer and executing said lower-level filter driver.

2. The method of claim 1, wherein said changing step of the Step (C) is to change an original device property of said IRP corresponding to a fixed storage device to a removable device property.

3. The method of claim 2, wherein said fixed storage device is a hard disk drive.

4. The method of claim 1, wherein said changing step of the Step (C) is to change an original device property of said IRP corresponding to a removable storage device to a fixed device property.

5. The method of claim 4, wherein said removable storage device is one selected from the collection of a compact flash memory card and a micro device hard disk drive.

6. The method of claim 1, wherein said storage device is a removable storage device.

7. The method of claim 1, wherein said storage device is a fixed storage device.

8. The method of claim 1, wherein said booting step of the Step (C) is to boot said computer to start a Windows operating system.
